(19) United States
(12) Patent Application Publication
(10) Pub. No.: US 2018/0249331 A1
(43) Pub. Date: Aug. 30, 2018

(54) SENB KEY UPDATE METHOD AND APPARATUS

(71) Applicant: HUAWEI TECHNOLOGIES CO., LTD., SHENZHEN (CN)

(72) Inventors: Jing CHEN, Shanghai (CN); Lijia ZHANG, Shenzhen (CN); Jingjing GUO, Beijing (CN)

(21) Appl. No.: 15/966,568

(22) Filed: Apr. 30, 2018

Related U.S. Application Data
(63) Continuation of application No. PCT/CN2015/093530, filed on Oct. 31, 2015.

(51) Int. Cl. H04W 12/04; H04W 76/27; H04W 76/10; H04W 4/50

(52) U.S. Cl. CPC H04W 12/04; H04W 76/27; H04L 9/08; H04W 4/50; H04W 76/10

(57) ABSTRACT

Embodiments of the present invention provide an SeNB key update method, including: establishing, by an MeNB, an RRC connection to UE, and determining a first SeNB and a second SeNB that are connected to the UE; calculating, by the MeNB, a key S-KeNB1 of the first SeNB and a key S-KeNB2 of the second SeNB, and sending an SeNB addition request to the first SeNB and the second SeNB; receiving, by the MeNB, a first request acknowledgment message fed back by the first SeNB, and receiving a second request acknowledgment message fed back by the second SeNB; and sending, by the MeNB, an RRC reconfiguration request to the UE according to the first request acknowledgment message and the second request acknowledgment message, where the RRC reconfiguration request includes key update information of the first SeNB and key update information of the second SeNB.

### CROSS-REFERENCE TO RELATED APPLICATIONS

This application is a continuation of International Application No. PCT/CN2015/093530, filed on Oct. 31, 2015, which is hereby incorporated by reference in its entirety.

### TECHNICAL FIELD

The present invention relates to the field of communications technologies, and in particular, to SeNB key update methods and apparatus.

### BACKGROUND

3GPP TS 36.300 describes a support feature of an evolved Universal Mobile Telecommunications System (UMTS) terrestrial radio access network (E-UTRAN) for dual connectivity. After configuring multiple Rx/Tx interfaces, user equipment (UE) in a Radio Resource Control (RRC) connection status may simultaneously use air interface resources that are provided by two evolved node base stations (eNB) in different locations. The two eNBs are connected using an X2 interface. FIG. 1 shows a control plane signaling procedure in a dual connectivity mode. An S1-mobility management entity (S1-MME) interface terminates at a master eNB (MeNB), and an X2 interface is used between the MeNB and a secondary eNB (SeNB). Each dual connectivity mode has only one S1-MME connection, and each eNB may independently process service and signaling requests of the UE. FIG. 2 shows a user plane data procedure in a dual connectivity mode, allowing two architectures: (1) S1-U terminates only at the MeNB, and user plane data is transmitted between the MeNB and the SeNB using an X2-U interface; and (2) the S1-U interface may also terminate at the SeNB.

For a procedure of key generation, update or encryption and decryption between one UE, one SeNB, and one MeNB, the MeNB maintains one key (set as an M-KeNB) and one SCG counter as input parameters to generate a new key (set as an S-KeNB). The MeNB separately sends the S-KeNB to the UE and the SeNB and uses the S-KeNB as an input parameter to generate a data stream encryption key Kupenc. When the S-KeNB needs to perform update, the MeNB increases a counting value of the SCG counter and separately sends an S-KeNB update procedure request to the UE and the SeNB. When the M-KeNB needs to perform update, an operation of the MeNB is to reset the counting value of the SCG counter to 0 and perform an S-KeNB update procedure.

The above described procedure is intended only for a case in which the UE is connected to a single SeNB and a single MeNB. However, the UE may also be simultaneously connected to N SeNBs. When n (n≤N) SeNBs request to the MeNB for S-KeNB key update, the described procedure does not provide an implementation of sending a key update request to the N SeNBs connected to the UE. Alternatively, data may be transmitted multiple times only in a manner of data transmission between UE and its connected single SeNB and single MeNB, that is, the MeNB needs to send key update signaling to the same UE n times. An increase of N leads to higher air interface resource consumption, increasing control plane signaling interaction.

### SUMMARY

Embodiments of the present invention provide an SeNB key update method and apparatus, and provide a key update procedure in a multi-SeNB scenario, so as to reduce times of control plane signaling interaction between an MeNB and UE, improve key update efficiency, and enhance user experience of key update.

A first aspect of the embodiments of the present invention provides an SeNB key update method, where the method may include:

establishing, by a master eNB (MeNB), a Radio Resource Control (RRC) connection to user equipment UE;

determining a first secondary eNB (SeNB) and a second SeNB that are

calculating, by the MeNB, a key S-KeNB1 of the first SeNB and a key S-KeNB2 of the second SeNB, and sending SeNB addition requests to the first SeNB and the second SeNB, where the addition requests include the S-KeNB1 or the S-KeNB2;

receiving, by the MeNB, a first request acknowledgment message corresponding to the SeNB addition request that is sent to the first SeNB, and receiving a second request acknowledgment message corresponding to the SeNB addition request that is sent to the second SeNB; and

sending, by the MeNB, an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In one embodiment, the calculating, by the MeNB, a key S-KeNB1 of the first SeNB and a key S-KeNB2 of the second SeNB includes:

obtaining, by the MeNB, a secondary cell group SCG counter and an MeNB key M-KeNB, and using a counting value of the SCG counter and the M-KeNB as input parameters, to calculate the key S-KeNB1 of the first SeNB and the key S-KeNB2 of the second SeNB, where

the S-KeNB1 is used to generate a data stream encryption key Kupenc1 corresponding to the first SeNB, and the S-KeNB2 is used to generate a data stream encryption key Kupenc2 corresponding to the second SeNB.

In one embodiment, the using a counting value of the SCG counter and the M-KeNB as input parameters, to calculate the key S-KeNB1 of the first SeNB and the key S-KeNB2 of the second SeNB includes:

obtaining a first counting value of the SCG counter, and calculating the S-KeNB1 with reference to the M-KeNB and the first counting value; and

obtaining a second counting value of the SCG counter, and calculating the S-KeNB2 with reference to the M-KeNB and the second counting value.

In one embodiment, the sending, by the MeNB, an RRC reconfiguration request to the UE according to the first request acknowledgment message and the second request acknowledgment message includes:

obtaining, by the MeNB, the key update information of the first SeNB from the first request acknowledgment message, and obtaining the key update information of the second SeNB from the second request acknowledgment message; and

adding, by the MeNB, the key update information of the first SeNB and the key update information of the second SeNB to the RRC reconfiguration request, and sending the RRC reconfiguration request to the UE, where

the RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure.

In one embodiment, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

A second aspect of the embodiments of the present invention provides an SeNB key update method, where the method may include:

establishing, by user equipment UE, a Radio Resource Control RRC connection to a master eNB MeNB, and establishing a connection to a first secondary eNB SeNB and a second SeNB;

receiving, by the UE, an RRC reconfiguration request sent by the MeNB, where the RRC reconfiguration request carries key update information of the first SeNB and key update information of the second SeNB; and

performing, by the UE, key update for the first SeNB and key update for the second SeNB according to the key update information of the first SeNB and the key update information of the second SeNB.

In one embodiment, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

In one embodiment, the performing, by the UE, key update for the first SeNB and key update for the second SeNB according to the key update information of the first SeNB and the key update information of the second SeNB includes:

calculating, by the UE, the key S-KeNB1 of the first SeNB according to the first counting value of the SCG counter and the M-KeNB that are carried in the key update information of the first SeNB;

calculating, by the UE, the key S-KeNB2 of the second SeNB according to the second counting value of the SCG counter and the M-KeNB that are carried in the key update information of the second SeNB;

calculating, by the UE, a data stream encryption key Kupenc1 corresponding to the first SeNB according to the first encryption algorithm version information and the S-KeNB1 that are carried in the key update information of the first SeNB;

calculating, by the UE, a data stream encryption key Kupenc2 corresponding to the second SeNB according to the second encryption algorithm version information and the S-KeNB2 that are carried in the key update information of the second SeNB; and

performing, by the UE, the key update for the first SeNB according to the S-KeNB1 and the Kupenc1, and performing the key update for the second SeNB according to the S-KeNB2 and the Kupenc2.

A third aspect of the embodiments of the present invention provides an SeNB key update apparatus, where the apparatus may include:

a connection module, configured to establish a Radio Resource Control RRC connection to user equipment UE;

a determining module, configured to determine a first secondary eNB SeNB and a second SeNB that are connected to the UE;

a calculation module, configured to calculate a key S-KeNB1 of the first SeNB determined by the determining module and a key S-KeNB2 of the second SeNB determined by the determining module;

a sending module, configured to send SeNB addition requests to the first SeNB and the second SeNB, where the addition requests carry the S-KeNB1 or the S-KeNB2; and

a receiving module, configured to: receive a first request acknowledgment message corresponding to the SeNB addition request that is sent to the first SeNB, and receive a second request acknowledgment message corresponding to the SeNB addition request that is sent to the second SeNB; where

the sending module is further configured to send an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In one embodiment, the calculation module is configured to:

obtain a secondary cell group SCG counter and an MeNB key M-KeNB, and use a counting value of the SCG counter and the M-KeNB as input parameters, to calculate the key S-KeNB1 of the first SeNB and the key S-KeNB2 of the second SeNB, where

the S-KeNB1 is used to generate a data stream encryption key Kupenc1 corresponding to the first SeNB, and the S-KeNB2 is used to generate a data stream encryption key Kupenc2 corresponding to the second SeNB.

In one embodiment, the calculation module is configured to:

obtain a first counting value of the SCG counter, and calculate the S-KeNB1 with reference to the M-KeNB; and

obtain a second counting value of the SCG counter, and calculate the S-KeNB2 with reference to the M-KeNB.

In one embodiment, the sending module is configured to:

send a first SeNB addition request to the first SeNB using an X2-C interface, where the first SeNB addition request carries a security capability of the UE and the S-KeNB1, so as to trigger the first SeNB to calculate the data stream encryption key Kupenc1 according to the security capability of the UE and the S-KeNB1; and send a second SeNB addition request to the second SeNB using the X2-C interface, where the second SeNB addition request carries the security capability of the UE and the S-KeNB2, so as to trigger the second SeNB to calculate the data stream encryption key Kupenc2 according to the security capability of the UE and the S-KeNB2.

In one embodiment, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

A fourth aspect of the embodiments of the present invention provides an SeNB key update method, where the apparatus may include:

a connection module, configured to: establish a Radio Resource Control RRC connection to a master eNB MeNB, and establish a connection to a first secondary eNB SeNB and a second SeNB;

a receiving module, configured to receive a RRC reconfiguration request sent by the MeNB, where the RRC reconfiguration request carries key update information of the first SeNB and key update information of the second SeNB; and

an update module, configured to perform a key update for the first SeNB and a key update for the second SeNB according to the key update information of the first SeNB received by the receiving module, and the key update information of the second SeNB received by the receiving module.

In one embodiment, the key update information of the first SeNB includes: a first air interface resource allocated by the first SeNB, first encryption algorithm version information selected by the first SeNB, and a first counting value of an SCG counter and the M-KeNB that are used to calculate the S-KeNB1; and

the key update information of the second SeNB includes: a second air interface resource allocated by the second SeNB, second encryption algorithm version information selected by the second SeNB, and a second counting value of the SCG counter and the M-KeNB that are used to calculate the S-KeNB2.

In one embodiment, the update module is configured to:

calculate the key S-KeNB1 of the first SeNB according to the first counting value of the SCG counter and the M-KeNB that are carried in the key update information of the first SeNB;

calculate the key S-KeNB2 of the second SeNB according to the second counting value of the SCG counter and the M-KeNB that are carried in the key update information of the second SeNB;

calculate a data stream encryption key Kupenc1 corresponding to the first SeNB according to the first encryption algorithm version information and the S-KeNB1 that are carried in the key update information of the first SeNB;

calculate a data stream encryption key Kupenc2 corresponding to the second SeNB according to the second encryption algorithm version information and the S-KeNB2 that are carried in the key update information of the second SeNB; and

perform the key update for the first SeNB according to the S-KeNB1 and the Kupenc1, and perform the key update for the second SeNB according to the S-KeNB2 and the Kupenc2.

A fifth aspect of the embodiments of the present invention provides a base station, where the base station may include: a memory, a connector, a processor, a sender, and a receiver, where the memory is connected to the sender and the receiver, and the processor is separately connected to the memory, the connector, the sender, and the receiver;

the memory stores a set of program code; and

the sender, the receiver, and the processor are configured to invoke the program code stored in the memory, to perform the following operations:

the connector is configured to establish a Radio Resource Control RRC connection to user equipment UE;

the processor is configured to determine a first secondary eNB SeNB and a second SeNB that are connected to the UE;

the processor is further configured to calculate a key S-KeNB1 of the first SeNB and a key S-KeNB2 of the second SeNB;

the sender is configured to send SeNB addition requests to the first SeNB and the second SeNB, where the addition requests carry the S-KeNB1 or the S-KeNB2;

the receiver is configured to: receive a first request acknowledgment message corresponding to the SeNB addition request that is sent to the first SeNB, and receive a second request acknowledgment message corresponding to the SeNB addition request that is sent to the second SeNB; and

the sender is further configured to send an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In one embodiment, the processor is configured to:

obtain a secondary cell group SCG counter and an MeNB key M-KeNB, and use a counting value of the SCG counter and the M-KeNB as input parameters, to calculate the key S-KeNB1 of the first SeNB and the key S-KeNB2 of the second SeNB, where

the S-KeNB1 is used to generate a data stream encryption key Kupenc1 corresponding to the first SeNB, and the S-KeNB2 is used to generate a data stream encryption key Kupenc2 corresponding to the second SeNB.

In one embodiment, the processor is configured to:

obtain a first counting value of the SCG counter, and calculate the S-KeNB1 with reference to the M-KeNB and the first counting value; and

obtain a second counting value of the SCG counter, and calculate the S-KeNB2 with reference to the M-KeNB and the second counting value.

In one embodiment, the sender is configured to:

send a first SeNB addition request to the first SeNB using an X2-C interface, where the first SeNB addition request carries a security capability of the UE and the S-KeNB1, so as to trigger the first SeNB to calculate the data stream encryption key Kupenc1 according to the security capability of the UE and the S-KeNB1; and

send a second SeNB addition request to the second SeNB using the X2-C interface, where the second SeNB addition request carries the security capability of the UE and the S-KeNB2, so as to trigger the second SeNB to calculate the data stream encryption key Kupenc2 according to the security capability of the UE and the S-KeNB2.

In one embodiment, the sender is configured to:

obtain the key update information of the first SeNB from the first request acknowledgment message, and obtain the key update information of the second SeNB from the second request acknowledgment message; and

add the key update information of the first SeNB and the key update information of the second SeNB to the RRC reconfiguration request, and send the RRC reconfiguration request to the UE, where

the RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure.

In one embodiment, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

A sixth aspect of the embodiments of the present invention provides user equipment, where the user equipment may include: a memory, a connector, a processor, and a receiver, where the memory is connected to the receiver, and the processor is separately connected to the memory, the connector, and the receiver;

the memory stores a set of program code; and

the receiver and the processor are configured to invoke the program code stored in the memory, to perform the following operations:

the connector is configured to: establish a Radio Resource Control RRC connection to a master eNB MeNB, and establish a connection to a first secondary eNB SeNB and a second SeNB;

the receiver is configured to receive an RRC reconfiguration request sent by the MeNB, where the RRC reconfiguration request carries key update information of the first SeNB and key update information of the second SeNB; and

the processor is configured to perform a key update for the first SeNB and a key update for the second SeNB according to the key update information of the first SeNB and the key update information of the second SeNB.

In one embodiment, the key update information of the first SeNB includes: a first air interface resource allocated by the first SeNB, first encryption algorithm version information selected by the first SeNB, and a first counting value of an SCG counter and the M-KeNB that are used to calculate the S-KeNB1; and

the key update information of the second SeNB includes: a second air interface resource allocated by the second SeNB, second encryption algorithm version information selected by the second SeNB, and a second counting value of the SCG counter and the M-KeNB that are used to calculate the S-KeNB2.

In one embodiment, the processor is configured to:

calculate the key S-KeNB1 of the first SeNB according to the first counting value of the SCG counter and the M-KeNB that are carried in the key update information of the first SeNB;

calculate the key S-KeNB2 of the second SeNB according to the second counting value of the SCG counter and the M-KeNB that are carried in the key update information of the second SeNB;

calculate a data stream encryption key Kupenc1 corresponding to the first SeNB according to the first encryption algorithm version information and the S-KeNB1 that are carried in the key update information of the first SeNB;

calculate a data stream encryption key Kupenc2 corresponding to the second SeNB according to the second encryption algorithm version information and the S-KeNB2 that are carried in the key update information of the second SeNB; and perform the key update for the first SeNB according to the S-KeNB1 and the Kupenc1, and perform the key update for the second SeNB according to the S-KeNB2 and the Kupenc2.

A seventh aspect of the embodiments of the present invention provides an SeNB key update system, including: the base station provided in the fifth aspect of the embodiments of the present invention, the user equipment provided in the sixth aspect of the embodiments of the present invention, and the secondary eNB SeNB that is connected to the user equipment.

In the embodiments of the present invention, the MeNB may first establish the RRC connection to the UE and determine each SeNB that is connected to the UE, and may further calculate a key S-KeNB of each SeNB. Each SeNB corresponds to one key. After calculating and obtaining the key of the SeNB, the MeNB may send the SeNB addition request to each SeNB, so as to send each key to a corresponding SeNB, and may further determine key update information of each SeNB according to a request acknowledgment message fed back by each SeNB. Further, the MeNB may add, to one RRC reconfiguration request, the key update information fed back by each SeNB, send the RRC reconfiguration request to the UE, and trigger the UE to perform key update for all the SeNBs using one RRC reconfiguration request, so as to reduce the times of the control plane signaling interaction, reduce power consumption of the MeNB and the UE, improve key update efficiency, and enhance user experience of the key update.

### BRIEF DESCRIPTION OF DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a control plane signaling procedure in a dual connectivity mode in the prior art;

FIG. 2 is a user plane data procedure in a dual connectivity mode in the prior art;

FIG. 3 is a schematic interaction diagram of key update in the prior art;

FIG. 4 is a schematic diagram of a topology of a multi-connection mode according to an embodiment of the present invention;

FIG. 5 is a schematic flowchart of an embodiment of an SeNB key update method according to an embodiment of the present invention;

FIG. 6 is a schematic structural diagram of another embodiment of an SeNB key update apparatus according to an embodiment of the present invention;

FIG. 7A and FIG. 7B are a schematic interaction diagram of an embodiment of an SeNB key update method according to an embodiment of the present invention;

FIG. 8A and FIG. 8B are a schematic interaction diagram of another embodiment of an SeNB key update method according to an embodiment of the present invention;

FIG. 9 is a schematic flowchart of another embodiment of an SeNB key update method according to an embodiment of the present invention;

FIG. 10 is a schematic structural diagram of an embodiment of an SeNB key update apparatus according to an embodiment of the present invention;

FIG. 11 is a schematic structural diagram of an embodiment of a base station according to an embodiment of the present invention; and

FIG. 12 is a schematic structural diagram of an embodiment of user equipment according to an embodiment of the present invention.

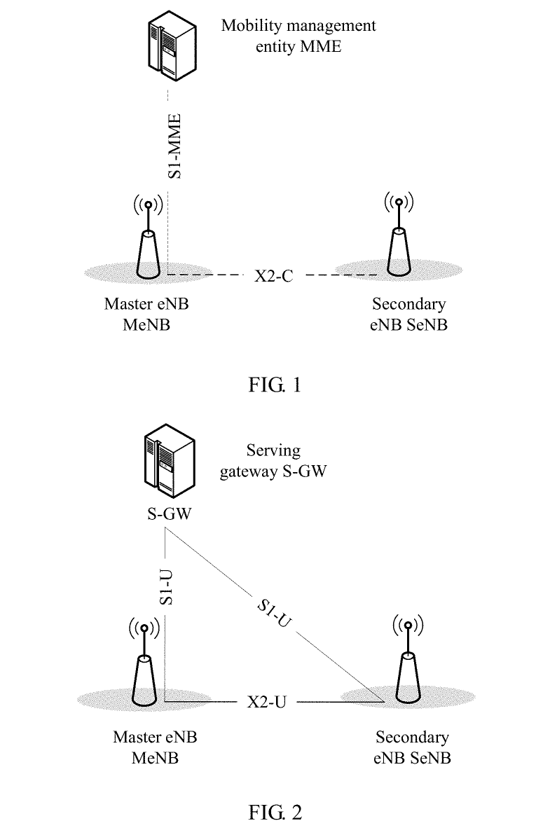

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

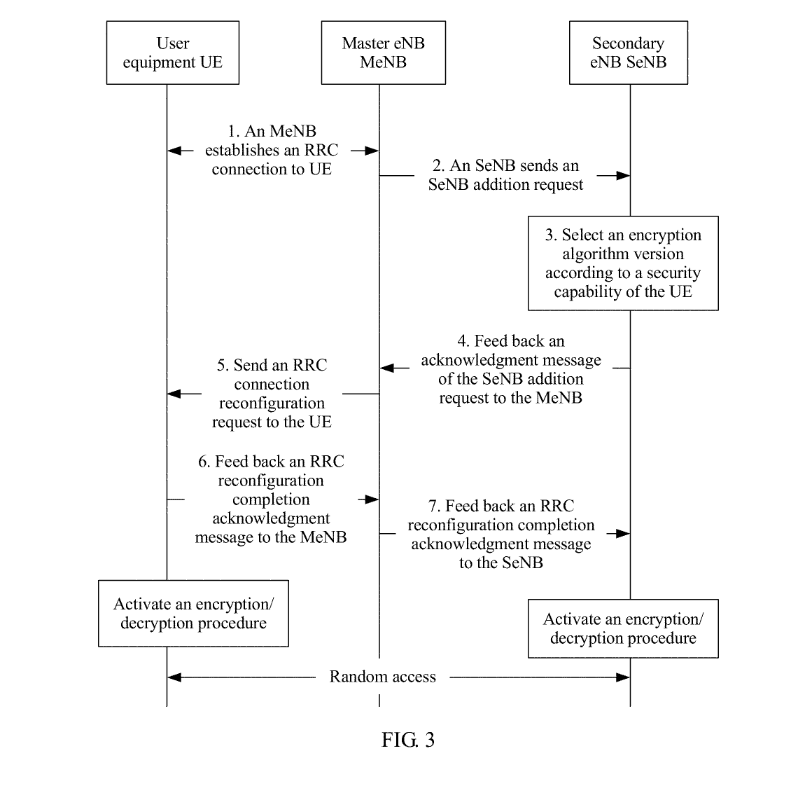

In an implementation, an embodiment of the present invention provides an SeNB key update system. The system may include UE, an MeNB, and an SeNB (which may include an SeNB1 and an SeNB2). With reference to FIG. 3 to FIG. 12, the following describes an SeNB key update method, apparatus and system provided in the embodiments of the present invention.

To better describe embodiments of the present invention, with reference to FIG. 3, a procedure is described when UE is connected to a single SeNB and a single MeNB, the UE, the MeNB and the SeNB perform key encryption or decryption in the prior art.

Referring to FIG. 3, FIG. 3 is a schematic interaction diagram of key update in the prior art. FIG. 3 shows a key update procedure between one UE, one SeNB, and one MeNB, including the following operations:

1. The MeNB establishes an RRC connection to the UE.

2. The MeNB sends an SeNB addition request to the SeNB, and initiates a key update procedure for the SeNB using the SeNB addition request. The SeNB addition request carries information such as a data stream encryption key Kupenc, and a security capability of the UE in a cross-platform standard format.

3. The SeNB selects an encryption algorithm version according to the security capability of the UE.

4. The SeNB feeds back an acknowledgment message of the SeNB addition request to the MeNB.

5. The MeNB sends an RRC connection reconfiguration request to the UE, where the RRC connection reconfiguration request carries information such as a counting value of an SCG counter and an encryption algorithm version.

6. The UE feeds back an RRC connection reconfiguration completion acknowledgment message to the MeNB.

7. The MeNB sends the reconfiguration completion acknowledgment message to the SeNB to complete key update.

As shown in the foregoing operations, the MeNB first establishes the RRC connection to the UE, and the MeNB maintains a key M-KeNB and a counting value of an SCG counter, so as to use the counting value of the SCG counter and the key M-KeNB as input parameters to generate a new key S-KeNB. The MeNB sends the S-KeNB to the SeNB, and the SeNB uses the S-KeNB as an input parameter to generate a data stream encryption key Kupenc. When the S-KeNB needs to perform update, the MeNB increases the counting value of the SCG counter and separately sends an S-KeNB update procedure request to the UE and the SeNB. When the M-KeNB needs to perform update, an operation of the MeNB is to reset the counting value of the SCG counter to 0 and perform an S-KeNB update procedure.

In an interaction process of the foregoing key update, the prior art is intended only for a case in which the UE is connected to a single SeNB and a single MeNB. If the UE is simultaneously connected to N SeNBs, when n (n≤N) SeNBs request S-KeNB key update from the MeNB, the MeNB needs to send key update signaling (a specific presentation may be the RRC connection reconfiguration request in FIG. 3) to same UE n times according to the update procedure described in FIG. 3. The foregoing key update signaling is a message that needs to be sent to the UE by an eNB on the air interface. When a key on one SeNB is updated, key update signaling needs to be sent once. When the UE is simultaneously connected to N SeNBs, keys on the N SeNBs need to be updated. Therefore, the key update signaling needs to be sent to the same UE n times. An increase of N leads to higher air interface resource consumption, increasing control plane signaling interaction. Likewise, when the M-KeNB needs to perform update, the MeNB also needs to send the key update signaling to the UE n times, increasing times of the control plane signaling interaction.

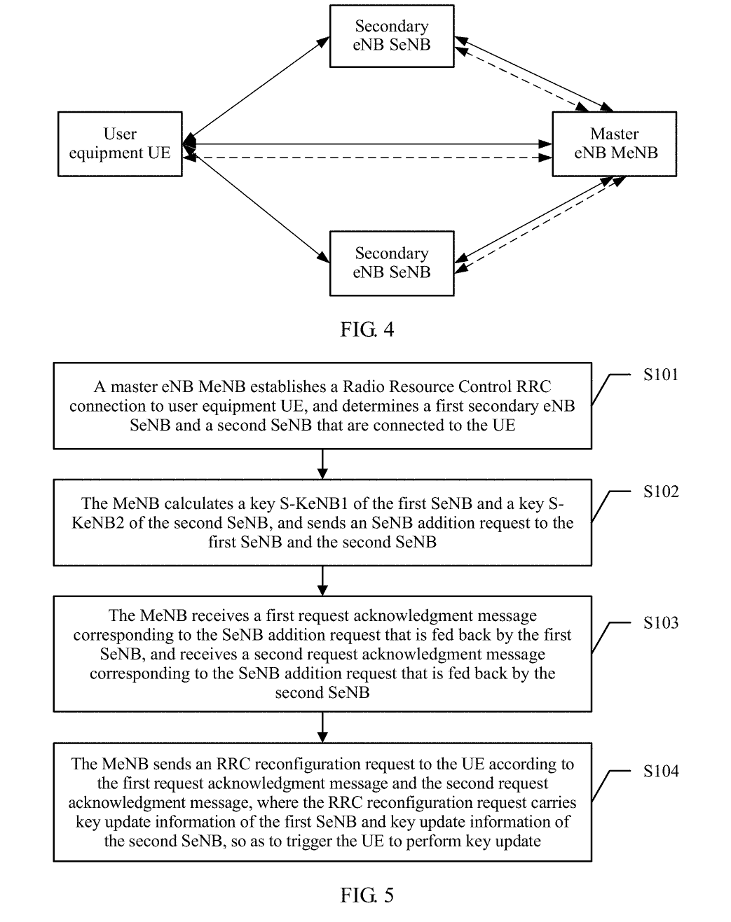

To correct a deficiency in the prior art such as high air interface resource consumption and multiple times of the control plane signaling interaction, this embodiment of the present invention provides a key update method. When multiple SeNBs concurrently request the key update, the SeNB addition request may be sent to the multiple SeNBs in same update processing, and then information fed back by the multiple SeNBs is added to one piece of key update signaling and is sent to the UE, so as to reduce the times of the control plane signaling interaction between the UE and the MeNB. Embodiments of the present invention may be applied to a multi-SeNB scenario. As shown in FIG. 4, the UE may be connected to the multiple SeNBs (this embodiment of the present invention uses two SeNBs as an example), a data radio bearer between the UE and the MeNB is distributed on the multiple SeNBs, and the MeNB may initiate a key update procedure for UE that needs to update a key and an SeNB associated with the UE. With reference to FIG. 5 to FIG. 9, the following describes a key update method and apparatus provided in embodiments of the present invention.

FIG. 5 is a schematic flowchart of an embodiment of a key update method according to an embodiment of the present invention. The key update method described in this embodiment of the present invention includes the following operations.

S101. A master eNB MeNB establishes a Radio Resource Control RRC connection to user equipment UE, and determines a first secondary eNB SeNB and a second SeNB that are connected to the UE.

In some embodiments, in dual connectivity, the MeNB described in embodiments of the present invention may be configured to maintain a key M-KeNB and an SCG counter to ensure key uniqueness between the UE and each SeNB. In one embodiment, when an SeNB key is updated, the MeNB may first establish the RRC connection to the UE, and further determine, according to a connection status between the UE and the SeNB, one or more SeNBs connected to the UE. Specifically, the UE may be connected to multiple SeNBs, and an embodiment of the present invention uses two SeNBs as an example for specific description. That is, after establishing the connection to the UE, the MeNB may determine a first SeNB and a second SeNB that are connected to the UE. The first SeNB and the second SeNB are merely examples, the first SeNB may be one of the multiple SeNBs connected to the UE, and the second SeNB may be any one or more of the multiple SeNBs connected to the UE other than the first SeNB. This is not limited herein.

S102. The MeNB calculates a key S-KeNB1 of the first SeNB and a key S-KeNB2 of the second SeNB, and sends an SeNB addition request to the first SeNB and the second SeNB.

In some embodiments, after determining the first SeNB (SeNB1 for short below) and the second SeNB (SeNB2 for short below), the MeNB may offload a data radio bearer (DRB) between the UE and the MeNB to the SeNB1 and the SeNB2. In one embodiment, the MeNB may maintain one SCG counter and one M-KeNB key, and use a counting value of the SCG counter and the M-KeNB key as input parameters to calculate two S-KeNB keys, that is, the S-KeNB1 and the S-KeNB2. That the MeNB maintains one SCG counter may be as follows: The MeNB obtains one SCG counter and stores the SCG counter in specified storage space, and then sets an initial counting value of the SCG counter to 0. Each time the MeNB determines one S-KeNB, the counting value of the SCG counter increases by 1. In one embodiment, the MeNB may use two different counting values of the SCG counter to respectively derive the key of the SeNB1 and the key of the SeNB2, that is, the S-KeNB1 and the S-KeNB2. After calculating and obtaining the S-KeNB1 and the S-KeNB2, the MeNB may send the S-KeNB1 to the SeNB1 and send the S-KeNB2 to the SeNB2, so that the SeNB1 and the SeNB2 calculate a data stream encryption key.

In some embodiments, the MeNB may send a first SeNB addition request to the SeNB1, so as to initiate a key update procedure to the SeNB1 using the first SeNB addition request. Specifically, the MeNB may send, to the SeNB1, the first SeNB addition request that carries the S-KeNB1, and add a security capability of the UE to the first SeNB addition request. After determining the security capability of the UE, the SeNB1 may select a first encryption algorithm version supported by the UE (that is, an encryption algorithm that is appropriate for the SeNB1 to perform a key update operation), and calculate a data stream encryption key Kupenc1 according to the S-KeNB1. In one embodiment, the MeNB may send the first SeNB addition request to the SeNB1, and may also send a second SeNB addition request to the SeNB2, so as to initiate a key update procedure to the SeNB2 using the second SeNB addition request. Specifically, the MeNB may send, to the SeNB2, the second SeNB addition request that carries the S-KeNB2, and add the security capability of the UE to the second SeNB addition request. After determining the security capability of the UE, the SeNB2 may select a second encryption algorithm supported by the UE (that is, an encryption algorithm that is appropriate for the SeNB2 to perform a key update operation), and calculate a data stream encryption key Kupenc2 according to the S-KeNB2. That is, the MeNB may simultaneously send the SeNB addition request to the SeNB1 and the SeNB2, so as to trigger the SeNB1 and the SeNB2 to simultaneously perform key updates, and improve key update efficiency and user experience. Specifically, the MeNB may send the S-KeNB1 to the SeNB1 and send the S-KeNB2 to the SeNB2 respectively at a same moment, or may send the S-KeNB1 to the SeNB1 and send the S-KeNB2 to the SeNB2 respectively within a preset time interval. A specific magnitude of the time interval is not limited herein. That is, the MeNB may calculate keys of the multiple SeNBs in one SeNB key update procedure, and further send a corresponding key to each SeNB, so as to trigger the multiple SeNBs to perform a related operation of the key update and save duration consumed by the multiple SeNBs for the key update operation.

S103. The MeNB receives a first request acknowledgment message corresponding to the SeNB addition request that is sent to the first SeNB, and receives a second request acknowledgment message corresponding to the SeNB addition request that is sent to the second SeNB.

S104. The MeNB sends an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In some embodiments, after the MeNB sends the first SeNB addition request to the SeNB1, the SeNB1 may allocate an available air interface resource to key update this time, select an appropriate encryption algorithm (that is, first encryption algorithm version information), and further calculate a data stream encryption key Kupenc1 of the key update this time according to a first counting value of the SCG counter that is used to calculate the S-KeNB1. Specifically, the SeNB1 may configure a priority list of the encryption algorithms supported by the UE according to multiple encryption algorithms supported by the UE and with reference to a working status of the UE in a practical application scenario. After receiving the first SeNB addition request sent by the MeNB, the SeNB1 may further select an encryption algorithm with a highest priority from the foregoing priority list according to the foregoing priority list, and determine the algorithm with the highest priority as the foregoing appropriate encryption algorithm. Likewise, the SeNB2 may also allocate an available air interface resource to the key update this time, select an appropriate encryption algorithm (that is, second encryption algorithm version information), and further calculate a data stream encryption key Kupenc2 of the key update this time according to a second counting value of the SCG counter that is used to calculate the S-KeNB2. In one embodiment, the SeNB1 and the SeNB2 may perform a same operation. The following uses an operation at an SeNB1 end as an example for brief description, and an operation at an SeNB2 end is not described again.

In some embodiments, after allocating the available air interface resource, selecting the corresponding encryption algorithm, and calculating and obtaining the encryption key Kupenc1 with reference to the first counting value, the SeNB1 may send the acknowledgment message of the SeNB addition request (that is, the first request acknowledgment message) to the MeNb, so as to feed back, to the MeNB, information such as the foregoing air interface resource, the first encryption algorithm version information, and the first counting value of the SCG counter and the M-KeNB that are used to calculate the S-KeNB1. The MeNB may receive the first request acknowledgment message that is fed back by the SeNB1 and that is of the first SeNB addition request, and obtain the key update information of the SeNB1 from the first request acknowledgment message. The key update information of the SeNB1 includes: a first air interface resource allocated by the first SeNB (that is, the SeNB1), the first encryption algorithm version information selected by the first SeNB, the first counting value of the SCG counter and the M-KeNB that are used to calculate the S-KeNB1, and the like. Further, the MeNB may receive the second request acknowledgment message that is fed back by the SeNB2 and that is of the second SeNB addition request, and obtain the key update information of the SeNB2 from the second request acknowledgment message. The key update information of the SeNB2 includes: a second air interface resource allocated by the second SeNB (that is, the SeNB2), the second encryption algorithm version information selected by the second SeNB, the second counting value of the SCG counter and the M-KeNB that are used to calculate the S-KeNB2, and the like.

In some embodiments, after obtaining the key update information of the SeNB1 and the key update information of the SeNB2, the MeNB may add the key update information of the SeNB1 and the key update information of the SeNB2 to the RRC reconfiguration request, and may further send the RRC reconfiguration request to the UE, so as to trigger the UE to perform the key update. The RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure. It should be noted that in this embodiment of the present invention, before sending the RRC reconfiguration request to the UE, the MeNB may collect key update information of all SeNBs connected to the UE (this embodiment of the present invention uses two SeNBs, the SeNB1 and the SeNB2, as an example for description), and may further add the key update information of all the SeNBs to one RRC reconfiguration request and send the RRC reconfiguration request to the UE, so as to trigger the UE to perform key updates for all the SeNBs. That is, the MeNB needs to send key update signaling to the UE only once to complete the key update between the UE and all the SeNBs. This reduces times of signaling interaction between the MeNB and the UE, save the air interface resource, and save power consumption of the MeNB and the UE.

Further, in some embodiments, the MeNB sends the RRC reconfiguration request to the UE, and the RRC reconfiguration request carries the key update information of the SeNB1 and the key update information of the SeNB2. After receiving the RRC reconfiguration request, the UE may calculate the S-KeNB1 according to the first counting value of the SCG counter and the M-KeNB that are included in the key update information carried in the RRC reconfiguration request, and calculate the S-KeNB2 according to the second counting value of the SCG counter and the M-KeNB that are included in the key update information carried in the RRC reconfiguration request. The UE may further calculate the data stream encryption key Kupenc1 according to the S-KeNB1 and the corresponding encryption algorithm version information, and calculate the data stream encryption key Kupenc2 according to the S-KeNB2 and the corresponding encryption algorithm version information. Further, the UE may perform the key update for the SeNB1 according to the encryption key S-KeNb1 and the Kupenc1, perform the key update for the SeNB2 according to the encryption key S-KeNb2 and the Kupenc2, and may further feed back an RRC reconfiguration completion acknowledgment message to the MeNB.

In one embodiment, the MeNB may receive the RRC reconfiguration completion acknowledgment message fed back by the UE, and may further separately send the RRC reconfiguration completion acknowledgment message to the SeNB1 and the SeNB2 using an X2-C interface, so as to complete the key update.

In this embodiment of the present invention, in a key update process, the MeNB may first establish the RRC connection to the UE and determine a quantity of the SeNBs connected to the UE, and may further calculate, according to the quantity of the SeNBs, a corresponding key S-KeNB. Each SeNB corresponds to one key. After calculating and obtaining multiple keys, the MeNB may send the SeNB addition request to each SeNB, so as to send each key to a corresponding SeNB, and may further determine information such as an allocated air interface resource, a selected encryption algorithm, and a calculated and obtained encryption key Kupenc of each SeNB according to a request acknowledgment message fed back by each SeNB. Further, the MeNB may add, to one RRC reconfiguration request, the key update information fed back by all SeNBs, send the RRC reconfiguration request to the UE, and use one RRC reconfiguration request to trigger the UE to perform key updates for all the SeNBs, so as to reduce times of control plane signaling interaction, reduce power consumption of the MeNB and the UE, improve key update efficiency, and enhance user experience of the key update.

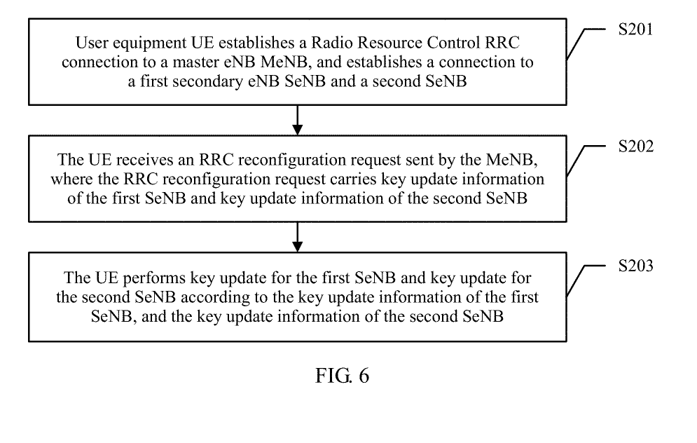

Referring to FIG. 6, FIG. 6 is a schematic flowchart of another embodiment of an SeNB key update method according to an embodiment of the present invention. The method described in this embodiment of the present invention includes the following operations:

S201. User equipment UE establishes a Radio Resource Control RRC connection to a master eNB MeNB, and establishes a connection to a first secondary eNB SeNB and a second SeNB.

S202. The UE receives an RRC reconfiguration request sent by the MeNB, where the RRC reconfiguration request carries key update information of the first SeNB and key update information of the second SeNB.

S203. The UE performs key update for the first SeNB and key update for the second SeNB according to the key update information of the first SeNB and the key update information of the second SeNB.

In some embodiments, the key update information of the first SeNB includes: a first air interface resource allocated by the first SeNB, first encryption algorithm version information selected by the first SeNB, and a first counting value of an SCG counter and the M-KeNB that are used to calculate the S-KeNB1; and

the key update information of the second SeNB includes: a second air interface resource allocated by the second SeNB, second encryption algorithm version information selected by the second SeNB, and a second counting value of the SCG counter and the M-KeNB that are used to calculate the S-KeNB2.

In some embodiments, the performing, by the UE, key update for the first SeNB and key update for the second SeNB according to the key update information of the first SeNB and the key update information of the second SeNB includes:

calculating, by the UE, the key S-KeNB1 of the first SeNB according to the first counting value of the SCG counter and the M-KeNB that are carried in the key update information of the first SeNB;

calculating, by the UE, the key S-KeNB2 of the second SeNB according to the second counting value of the SCG counter and the M-KeNB that are carried in the key update information of the second SeNB;

calculating, by the UE, a data stream encryption key Kupenc1 corresponding to the first SeNB according to the first encryption algorithm version information and the S-KeNB1 that are carried in the key update information of the first SeNB;

calculating, by the UE, a data stream encryption key Kupenc2 corresponding to the second SeNB according to the second encryption algorithm version information and the S-KeNB2 that are carried in the key update information of the second SeNB; and performing, by the UE, the key update for the first SeNB according to the

S-KeNB1 and the Kupenc1, and performing the key update for the second SeNB according to the S-KeNB2 and the Kupenc2.

In one embodiment, the SeNB key update method described in this embodiment corresponding to FIG. 6 is executed by the UE described in this embodiment of the present invention. For one embodiment process in which the UE interacts with the MeNB and the SeNB to perform the SeNB key update, refer to an embodiment corresponding to FIG. 5.

In one embodiment of the present invention, in a key update process, the UE may first establish the RRC connection to the MeNB and establish the connection to the SeNB, and may further receive the RRC reconfiguration request sent by the MeNB. The UE calculates keys of all SeNBs and data stream encryption keys corresponding to all the SeNBs according to key update information that is carried in the RRC reconfiguration request and that is of all the SeNBs, so as to trigger all the SeNBs to update the keys. This may reduce times of control plane signaling interaction between the UE and the MeNB, reduce power consumption of the MeNB and the UE, improve key update efficiency, and enhance user experience of the key update.

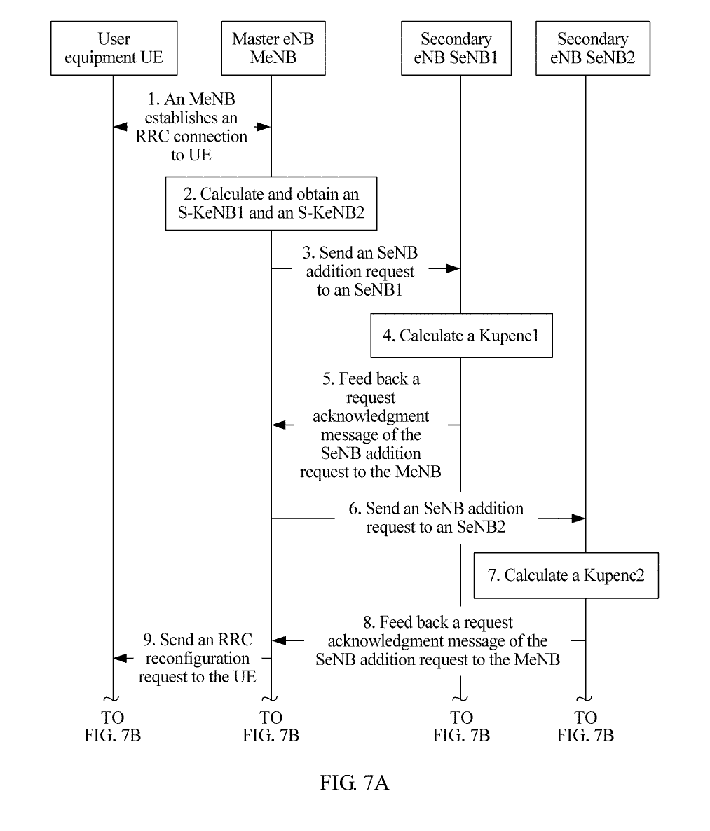

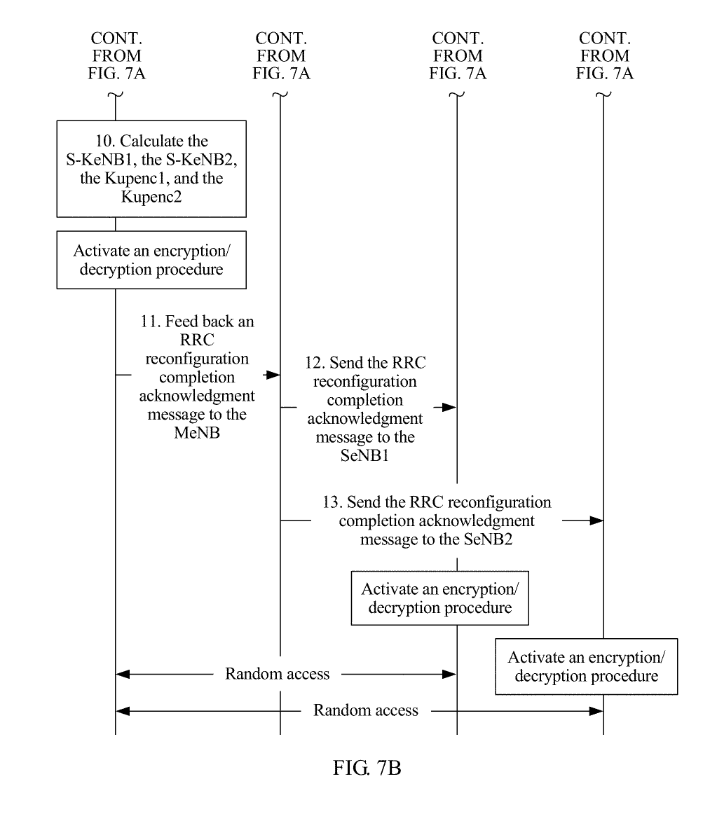

With reference to FIG. 7A and FIG. 7B, the following describes an interaction process among an MeNB, UE, an SeNB1, and an SeNB2 in a key update method described in an embodiment of the present invention. The interaction process among the MeNB, the UE, the SeNB1, and the SeNB2 described in this embodiment of the present invention includes the following operations:

1. The MeNB establishes an RRC connection to the UE.

2. The MeNB determines to offload a DEB to the SeNB1 and the SeNB2. The MeNB maintains one SCG counter and one MeNB key M-KeNB, calculates an S-KeNB1 according to a first counting value of the SCG counter and the M-KeNB, and calculates an S-KeNB2 according to a second counting value of the SCG counter and the M-KeNB.

3. The MeNB sends an SeNB addition request to the SeNB1 using an X2-C interface, and initiates a key update procedure to the SeNB1 using the SeNB addition request. The SeNB addition request carries a data stream encryption key S-KeNB1.

4. The SeNB1 allocates an available air interface resource to key update, and selects an appropriate encryption algorithm to calculate the encryption decryption key Kupenc1.

5. The SeNB1 feeds back a request acknowledgment message of the SeNB addition request to the MeNB, so as to indicate information such as the allocated air interface resource, the counting value of the SCG counter that is used to calculate the Kupenc1, and the encryption algorithm selected by the SeNB1.

6. The MeNB sends an SeNB addition request to the SeNB2 using the X2-C interface, and initiates a key update procedure to the SeNB2 using the SeNB addition request. The SeNB addition request carries a data stream encryption key S-KeNB2.

7. The SeNB2 allocates an available air interface resource to key update, and selects an appropriate encryption algorithm to calculate the encryption decryption key Kupenc2.

8. The SeNB2 feeds back a request acknowledgment message of the SeNB addition request to the MeNB, so as to indicate information such as the allocated air interface resource, the counting value of the SCG counter that is used to calculate the Kupenc2, and the encryption algorithm selected by the SeNB2.

9. The MeNB sends an RRC reconfiguration request to the UE, where the RRC reconfiguration request carries key update information of the SeNB1 and key update information of the SeNB2. For the key update information of the SeNB1 and the key update information of the SeNB2, refer to information described in an embodiment corresponding to FIG. 5.

10. The UE calculates the S-KeNB1 key and the S-KeNB2 key for connection to the SeNB1 and the SeNB2 that are associated with the UE, and calculates the encryption decryption key Kupenc1 and the encryption decryption key Kupenc2, so as to activate an encryption and decryption procedure.

11. The UE feeds back an RRC reconfiguration completion acknowledgment message to the MeNB.

12. The MeNB sends the RRC reconfiguration completion acknowledgment message to the SeNB1 using the X2-C interface, so as to trigger the SeNB1 to activate the encryption and decryption procedure.

13. The MeNB sends the RRC reconfiguration completion acknowledgment message to the SeNB2 using the X2-C interface, so as to trigger the SeNB2 to activate the encryption and decryption procedure.

Further, a random access procedure may be started between the UE and the SeNB1 or the SeNB2.

For a specific implementation process of each operation shown in the interaction procedure corresponding to FIG. 7A and FIG. 7B, refer to embodiments corresponding to FIG. 5.

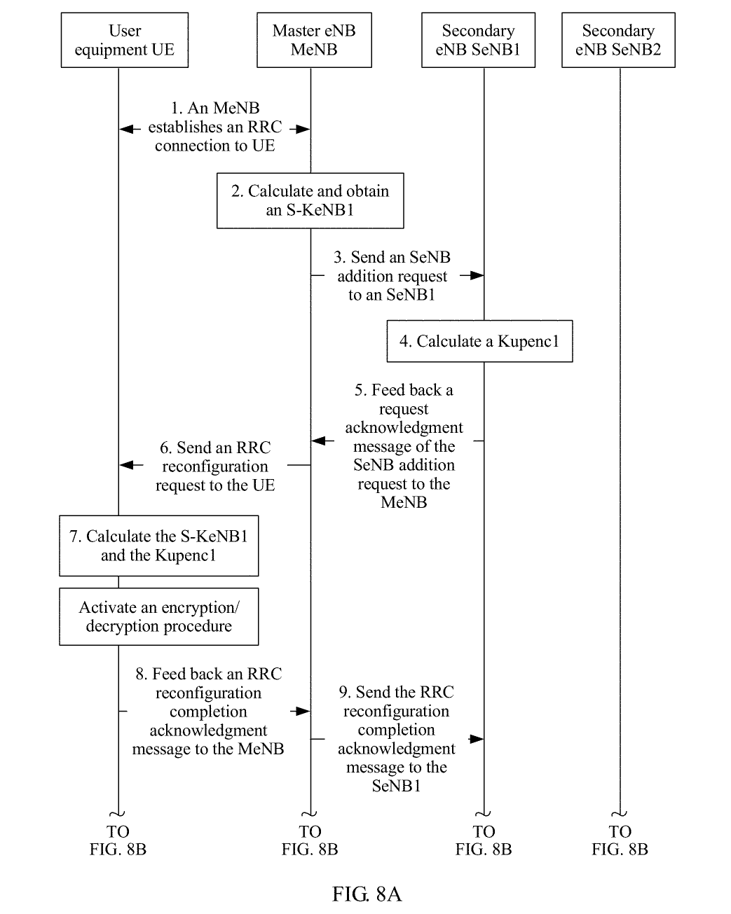

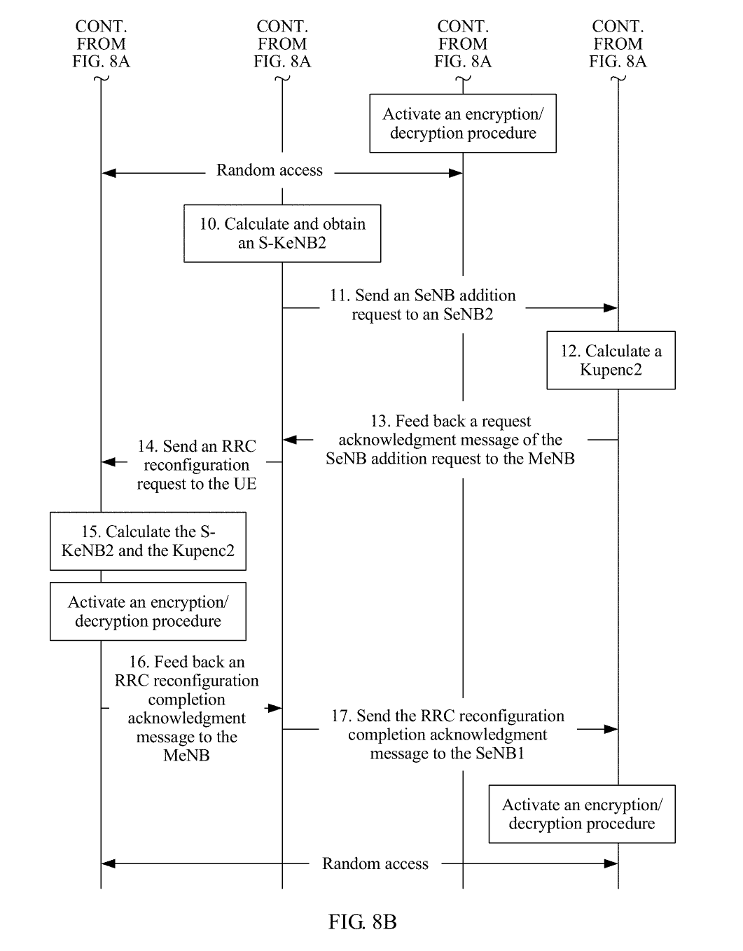

In one embodiment, in a multi-SeNB scenario, in the key update method described in this embodiment of the present invention, the MeNB may also separately initiate a key update procedure to the SeNB1 and the SeNB2 twice. The following gives specific description with reference to FIG. 8A and FIG. 8B.

Referring to FIG. 8A and FIG. 8B, FIG. 8A and FIG. 8B are another interaction diagram of an MeNB, UE, an SeNB1 and an SeNB2 in a key update method according to an embodiment of the present invention, including the following operations:

1. The MeNB establishes an RRC connection to the UE.

2. The MeNB determines to offload a DRB to the SeNB1. The MeNB maintains one SCG counter and one MeNB key M-KeNB, and calculates an S-KeNB1 according to a first counting value of the SCG counter and the M-KeNB.

3. The MeNB sends an SeNB addition request to the SeNB1 using an X2-C interface, and initiates a key update procedure to the SeNB1 using the SeNB addition request. The SeNB addition request carries a data stream encryption key S-KeNB1.

4. The SeNB1 allocates an available air interface resource to key update, and selects an appropriate encryption algorithm to calculate the encryption decryption key Kupenc1.

5. The SeNB1 feeds back a request acknowledgment message of the SeNB addition request to the MeNB, so as to indicate information such as the allocated air interface resource, the counting value of the SCG counter that is used to calculate the Kupenc1, and the encryption algorithm selected by the SeNB1.

6. The MeNB sends an RRC reconfiguration request to the UE, where the RRC connection reconfiguration request carries key update information of the SeNB1. For the key update information of the SeNB1, refer to information described in embodiments corresponding to FIG. 5.

7. After receiving the RRC reconfiguration request sent by the MeNB, the UE calculates the S-KeNB1 key for the SeNB1 associated with the UE and calculates the encryption decryption key Kupenc1, so as to activate an encryption and decryption procedure.

8. The UE feeds back an RRC reconfiguration completion acknowledgment message to the MeNB.

9. The MeNB sends the RRC reconfiguration completion acknowledgment message to the SeNB1 using the X2-C interface, so as to trigger the SeNB1 to activate the encryption and decryption procedure. After receiving the foregoing acknowledgment message, the SeNB1 may choose to activate the encryption and decryption procedure. After receiving a random access request message sent by the UE, the SeNB1 may further choose to start the encryption and decryption procedure.

10. The MeNB determines to offload the DEB to the SeNB2. The MeNB maintains the SCG counter and the MeNB key M-KeNB, and calculates an S-KeNB2 according to a second counting value of the SCG counter and the M-KeNB.

11. The MeNB sends an SeNB addition request to the SeNB2 using the X2-C interface, and initiates a key update procedure to the SeNB2 using the SeNB addition request. The SeNB addition request carries a data stream encryption key S-KeNB2.

12. The SeNB2 allocates an available air interface resource to key update, and selects an appropriate encryption algorithm to calculate the encryption decryption key Kupenc2.

13. The SeNB2 feeds back a request acknowledgment message of the SeNB addition request to the MeNB, so as to indicate information such as the allocated air interface resource, the counting value of the SCG counter that is used to calculate the Kupenc2, and the encryption algorithm selected by the SeNB2.

14. The MeNB sends an RRC reconfiguration request to the UE, where the RRC connection reconfiguration request carries key update information of the SeNB2. For the key update information of the SeNB2, refer to information described in the embodiments corresponding to FIG. 5.

15. After receiving the RRC reconfiguration request sent by the MeNB, the UE calculates the S-KeNB2 key for the SeNB2 associated with the UE and calculates the encryption decryption key Kupenc2, so as to activate an encryption and decryption procedure.

16. The UE feeds back an RRC reconfiguration completion acknowledgment message to the MeNB.

17. The MeNB sends the RRC reconfiguration completion acknowledgment message to the SeNB2 using the X2-C interface, so as to trigger the SeNB2 to activate the encryption and decryption procedure. After receiving the foregoing acknowledgment message, the SeNB2 may choose to activate the encryption and decryption procedure. After receiving a random access request message sent by the UE, the SeNB2 may further choose to start the encryption and decryption procedure.

In one embodiment, the implementation shown in an interaction procedure corresponding to FIG. 8A and FIG. 8B is also applicable to a multi-SeNB scenario, and the MeNB may separately initiate a key update processing procedure to the SeNB1 and the SeNB2 twice. That is, the MeNB may not only simultaneously initiate the key update processing procedure to the SeNB1 and the SeNB2, but also separately initiate the key update processing procedure to the SeNB1 and the SeNB2 twice. A specific implementation may be determined according to an actual application scenario, and this is not limited herein. For a specific implementation process of each operation shown in the foregoing interaction procedure, refer to an implementation described in each operation of an embodiment corresponding to FIG. 5.

In one embodiment of the present invention, in a key update process, the MeNB may first establish the RRC connection to the UE and determine a quantity of the SeNBs connected to the UE, and may further calculate, according to the quantity of the SeNBs, corresponding key S-KeNBs, including the S-KeNB1 and the S-KeNB2. After calculating and obtaining multiple keys, the MeNB may simultaneously send the SeNB addition request to each SeNB, so as to send each key to a corresponding SeNB, and may further determine information such as an allocated air interface resource, a selected encryption algorithm, and a calculated and obtained encryption key Kupenc of each SeNB according to a request acknowledgment message fed back by each SeNB. Further, the MeNB may send the RRC reconfiguration request to the UE according to the information fed back by each SeNB, and may further simultaneously send the reconfiguration acknowledgment message to each SeNB according to the RRC reconfiguration completion acknowledgment message fed back by the UE, so as to trigger each SeNB to activate the encryption and decryption procedure. This may reduce times of control plane signaling interaction and improve key update efficiency. Further, after calculating the corresponding key S-KeNBs according to the quantity of the SeNBs, the MeNB may separately send the SeNB addition request to each SeNB multiple times, so as to send each key to the corresponding SeNB, and may further determine the information such as the allocated air interface resource, the selected encryption algorithm and the calculated and obtained encryption key Kupenc of each SeNB according to the request acknowledgment message fed back by each SeNB. This increases an implementation of the key update and enhances user experience of the key update.

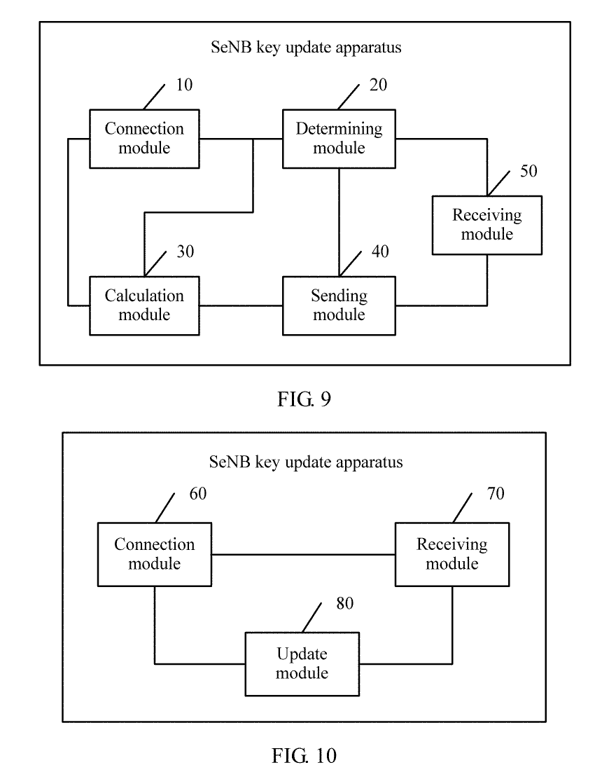

Referring to FIG. 9, FIG. 9 is a schematic structural diagram of an embodiment of an SeNB key update apparatus according to an embodiment of the present invention. The apparatus described in an embodiment of the present invention includes:

a connection module 10, configured to establish a Radio Resource Control RRC connection to user equipment UE;

a determining module 20, configured to determine a first secondary eNB SeNB and a second SeNB that are connected to the UE;

a calculation module 30, configured to calculate a key S-KeNB1 of the first SeNB determined by the determining module and a key S-KeNB2 of the second SeNB determined by the determining module;

a sending module 40, configured to send an SeNB addition request to the first SeNB and the second SeNB, where the addition request carries the S-KeNB1 or the S-KeNB2; and

a receiving module 50, configured to: receive a first request acknowledgment message corresponding to the SeNB addition request that is sent to the first SeNB, and receive a second request acknowledgment message corresponding to the SeNB addition request that is sent to the second SeNB; where

the sending module 40 is further configured to send an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In some embodiments, the calculation module 30 is configured to:

obtain a secondary cell group SCG counter and an MeNB key M-KeNB, and use a counting value of the SCG counter and the M-KeNB as input parameters, to calculate the key S-KeNB1 of the first SeNB and the key S-KeNB2 of the second SeNB.

The S-KeNB1 is used to generate a data stream encryption key Kupenc1 corresponding to the first SeNB, and the S-KeNB2 is used to generate a data stream encryption key Kupenc2 corresponding to the second SeNB.

In some feasible implementations, the calculation module 30 is configured to:

obtain a first counting value of the SCG counter, and calculate the S-KeNB1 with reference to the M-KeNB; and

obtain a second counting value of the SCG counter, and calculate the S-KeNB2 with reference to the M-KeNB.

In some embodiments, the sending module 40 is configured to:

send a first SeNB addition request to the first SeNB using an X2-C interface, where the first SeNB addition request carries a security capability of the UE and the S-KeNB1, so as to trigger the first SeNB to calculate the data stream encryption key Kupenc1 according to the security capability of the UE and the S-KeNB1; and

send a second SeNB addition request to the second SeNB using the X2-C interface, where the second SeNB addition request carries the security capability of the UE and the S-KeNB2, so as to trigger the second SeNB to calculate the data stream encryption key Kupenc2 according to the security capability of the UE and the S-KeNB2.

In some embodiments, the sending module 40 is configured to:

obtain the key update information of the first SeNB from the first request acknowledgment message, and obtain the key update information of the second SeNB from the second request acknowledgment message; and

add the key update information of the first SeNB and the key update information of the second SeNB to the RRC reconfiguration request, and send the RRC reconfiguration request to the UE.

The RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure.

In some embodiments, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

In one embodiment, the SeNB key update apparatus may be an MeNB. The MeNB may perform an SeNB key update method using each built-in module of the MeNB.

In an embodiment of the present invention, in a key update process, the MeNB may first establish the RRC connection to the UE and determine a quantity of the SeNBs connected to the UE, and may further calculate, according to the quantity of the SeNBs, a corresponding key S-KeNB. Each SeNB corresponds to one key. After calculating and obtaining multiple keys, the MeNB may send the SeNB addition request to each SeNB, so as to send each key to a corresponding SeNB, and may further determine information such as an allocated air interface resource, a selected encryption algorithm, and a calculated and obtained encryption key Kupenc of each SeNB according to a request acknowledgment message fed back by each SeNB. Further, the MeNB may add, to one RRC reconfiguration request, the key update information fed back by all SeNBs, send the RRC reconfiguration request to the UE, and use one RRC reconfiguration request to trigger the UE to perform key updates for all the SeNBs, so as to reduce times of control plane signaling interaction, reduce power consumption of the MeNB and the UE, improve key update efficiency, and enhance user experience of the key update.

Referring to FIG. 10, FIG. 10 is a schematic structural diagram of another embodiment of an SeNB key update apparatus according to an embodiment of the present invention. The apparatus described in this embodiment of the present invention includes:

a connection module 60, configured to: establish a Radio Resource Control RRC connection to a master eNB MeNB, and establish a connection to a first secondary eNB SeNB and a second SeNB;

a receiving module 70, configured to receive an RRC reconfiguration request sent by the MeNB, where the RRC reconfiguration request carries key update information of the first SeNB and key update information of the second SeNB; and

an update module 80, configured to perform a key update for the first SeNB and a key update for the second SeNB according to the key update information of the first SeNB received by the receiving module, and the key update information of the second SeNB received by the receiving module.

In some embodiments, the key update information of the first SeNB includes: a first air interface resource allocated by the first SeNB, first encryption algorithm version information selected by the first SeNB, and a first counting value of an SCG counter and the M-KeNB that are used to calculate the S-KeNB1; and

the key update information of the second SeNB includes: a second air interface resource allocated by the second SeNB, second encryption algorithm version information selected by the second SeNB, and a second counting value of the SCG counter and the M-KeNB that are used to calculate the S-KeNB2.

In one embodiment, the SeNB key update apparatus described in this embodiment of the present invention may be an UE provided in an embodiment of the present invention. The UE may perform an implementation described in an embodiment of an SeNB key update method using each built-in module of the UE.

In an embodiment of the present invention, in a key update process, the UE may first establish the RRC connection to the MeNB and establish the connection to the SeNB, and may further receive the RRC reconfiguration request sent by the MeNB. The UE calculates keys of all SeNBs and data stream encryption keys corresponding to all the SeNBs according to key update information that is carried in the RRC reconfiguration request and that is of all the SeNBs, so as to trigger all the SeNBs to update the keys. This may reduce times of control plane signaling interaction between the UE and the MeNB, reduce power consumption of the MeNB and the UE, improve key update efficiency, and enhance user experience of the key update.

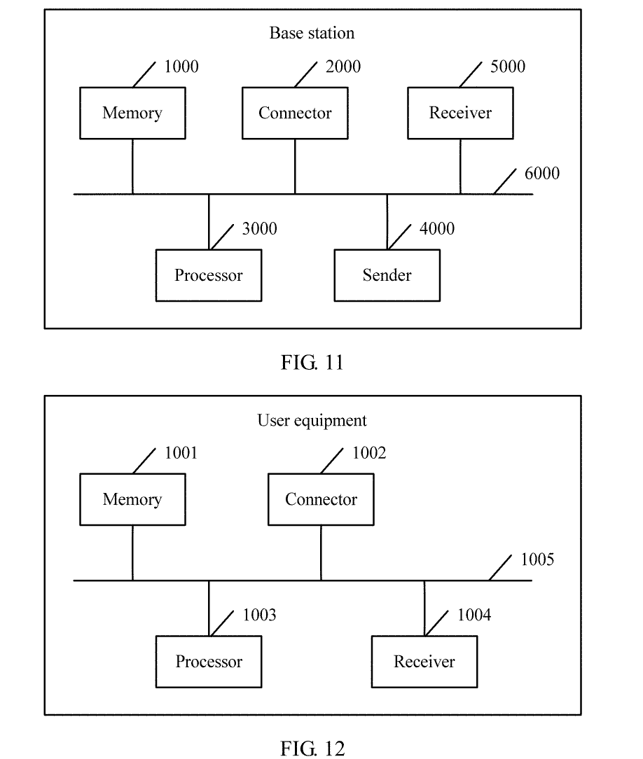

Referring to FIG. 11, FIG. 11 is a schematic structural diagram of an embodiment of a base station according to an embodiment of the present invention. The base station described in this embodiment of the present invention includes: a memory 1000, a connector 2000, a processor 3000, a sender 4000, and a receiver 5000, where the memory 1000, the connector 2000, the processor 3000, the sender 4000, and the receiver 5000 may be connected using a bus 6000; the memory 1000 stores a set of program code; and

the sender 4000, the receiver 5000, and the processor 3000 are configured to invoke the program code stored in the memory 1000, to perform the following operations:

The connector 2000 is configured to establish a Radio Resource Control RRC connection to user equipment UE.

The processor 3000 is configured to determine a first secondary eNB SeNB and a second SeNB that are connected to the UE.

The processor 3000 is further configured to calculate a key S-KeNB1 of the first SeNB and a key S-KeNB2 of the second SeNB.

The sender 4000 is configured to send an SeNB addition request to the first SeNB and the second SeNB, where the addition request carries the S-KeNB1 or the S-KeNB2.

The receiver 5000 is configured to: receive a first request acknowledgment message corresponding to the SeNB addition request that is sent to the first SeNB, and receive a second request acknowledgment message corresponding to the SeNB addition request that is sent to the second SeNB.

The sender 4000 is further configured to send an RRC reconfiguration request to the UE according to the first request acknowledgment message and the second request acknowledgment message, where the RRC reconfiguration request carries key update information of the first SeNB and key update information of the second SeNB, so as to trigger the UE to perform a key update.

In some embodiments, the processor 3000 is configured to:

obtain a secondary cell group SCG counter and an MeNB key M-KeNB, and use a counting value of the SCG counter and the M-KeNB as input parameters, to calculate the key S-KeNB1 of the first SeNB and the key S-KeNB2 of the second SeNB.

The S-KeNB1 is used to generate a data stream encryption key Kupenc1 corresponding to the first SeNB, and the S-KeNB2 is used to generate a data stream encryption key Kupenc2 corresponding to the second SeNB.

In some embodiments, the processor 3000 is configured to:

obtain a first counting value of the SCG counter, and calculate the S-KeNB1 with reference to the M-KeNB; and

obtain a second counting value of the SCG counter, and calculate the S-KeNB2 with reference to the M-KeNB.

In some embodiments, the sender 4000 is configured to:

send a first SeNB addition request to the first SeNB using an X2-C interface, where the first SeNB addition request carries a security capability of the UE and the S-KeNB1, so as to trigger the first SeNB to calculate the data stream encryption key Kupenc1 according to the security capability of the UE and the S-KeNB1; and

send a second SeNB addition request to the second SeNB using the X2-C interface, where the second SeNB addition request carries the security capability of the UE and the S-KeNB2, so as to trigger the second SeNB to calculate the data stream encryption key Kupenc2 according to the security capability of the UE and the S-KeNB2.

In some embodiments, the sender 4000 is configured to:

obtain the key update information of the first SeNB from the first request acknowledgment message, and obtain the key update information of the second SeNB from the second request acknowledgment message; and

add the key update information of the first SeNB and the key update information of the second SeNB to the RRC reconfiguration request, and send the RRC reconfiguration request to the UE.

The RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure.

In some embodiments, the key update information of the first SeNB includes: a first air interface resource allocated by the first SeNB, first encryption algorithm version information selected by the first SeNB, and the first counting value of the SCG counter and the M-KeNB that are used to calculate the S-KeNB1; and

the key update information of the second SeNB includes: a second air interface resource allocated by the second SeNB, second encryption algorithm version information selected by the second SeNB, and the second counting value of the SCG counter and the M-KeNB that are used to calculate the S-KeNB2.

In one embodiment, the base station described in an embodiment of the present invention may be an MeNB. The MeNB may perform an implementation described in an embodiment of an SeNB key update method using each built-in module of the MeNB.

In an embodiment of the present invention, in a key update process, the MeNB may first establish the RRC connection to the UE and determine a quantity of the SeNBs connected to the UE, and may further calculate, according to the quantity of the SeNBs, a corresponding key S-KeNB. Each SeNB corresponds to one key. After calculating and obtaining multiple keys, the MeNB may send the SeNB addition request to each SeNB, so as to send each key to a corresponding SeNB, and may further determine information such as an allocated air interface resource, a selected encryption algorithm, and a calculated and obtained encryption key Kupenc of each SeNB according to a request acknowledgment message fed back by each SeNB. Further, the MeNB may add, to one RRC reconfiguration request, the key update information fed back by all SeNBs, send the RRC reconfiguration request to the UE, and use one RRC reconfiguration request to trigger the UE to perform key updates for all the SeNBs, so as to reduce times of control plane signaling interaction, reduce power consumption of the MeNB and the UE, improve key update efficiency, and enhance user experience of the key update.

Referring to FIG. 12, FIG. 12 is a schematic structural diagram of an embodiment of user equipment according to an embodiment of the present invention. The base station described in this embodiment of the present invention includes: a memory 1001, a connector 1002, a processor 1003, and a receiver 1004, where the memory 1001, the connector 1002, the processor 1003, and the receiver 1004 may be connected using a bus 1005; the memory stores a set of program code; and

the receiver 1004 and the processor 1003 are configured to invoke the program code stored in the memory 1001, to perform the following operations:

The connector 1002 is configured to: establish a Radio Resource Control RRC connection to a master eNB MeNB, and establish a connection to a first secondary eNB SeNB and a second SeNB.

The receiver 1004 is configured to receive an RRC reconfiguration request sent by the MeNB, where the RRC reconfiguration request carries key update information of the first SeNB and key update information of the second SeNB.

The processor 1003 is configured to perform a key update for the first SeNB and a key update for the second SeNB according to the key update information of the first SeNB, and the key update information of the second SeNB.

In some embodiments, the key update information of the first SeNB includes: a first air interface resource allocated by the first SeNB, first encryption algorithm version information selected by the first SeNB, and a first counting value of an SCG counter and the M-KeNB that are used to calculate the S-KeNB1; and

the key update information of the second SeNB includes: a second air interface resource allocated by the second SeNB, second encryption algorithm version information selected by the second SeNB, and a second counting value of the SCG counter and the M-KeNB that are used to calculate the S-KeNB2.

In some embodiments, the processor 1003 is configured to:

calculate the key S-KeNB1 of the first SeNB according to the first counting value of the SCG counter and the M-KeNB that are carried in the key update information of the first SeNB;

calculate the key S-KeNB2 of the second SeNB according to the second counting value of the SCG counter and the M-KeNB that are carried in the key update information of the second SeNB;

calculate a data stream encryption key Kupenc1 corresponding to the first SeNB according to the first encryption algorithm version information and the S-KeNB1 that are carried in the key update information of the first SeNB;

calculate a data stream encryption key Kupenc2 corresponding to the second SeNB according to the second encryption algorithm version information and the S-KeNB2 that are carried in the key update information of the second SeNB; and

perform the key update for the first SeNB according to the S-KeNB1 and the Kupenc1, and perform the key update for the second SeNB according to the S-KeNB2 and the Kupenc2.

In an embodiment of the present invention, in a key update process, the UE may first establish the RRC connection to the MeNB and establish the connection to the SeNB, and may further receive the RRC reconfiguration request sent by the MeNB. The UE calculates keys of all SeNBs and data stream encryption keys corresponding to all the SeNBs according to key update information that is carried in the RRC reconfiguration request and that is of all the SeNBs, so as to trigger all the SeNBs to update the keys. This may reduce times of control plane signaling interaction between the UE and the MeNB, reduce power consumption of the MeNB and the UE, improve key update efficiency, and enhance user experience of the key update.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (Read-Only Memory, ROM), or a random access memory (Random Access Memory, RAM).

What is disclosed above is merely example embodiments of the present invention, and certainly is not intended to limit the protection scope of the present invention. Therefore, equivalent variations made in accordance with the claims of the present invention shall fall within the scope of the present invention.

What is claimed is:

1. An SeNB key update method, comprising:
establishing, by a master eNB (MeNB), a Radio Resource Control (RRC) connection to user equipment UE;
determining a first secondary eNB (SeNB) and a second SeNB that are connected to the UE;
calculating, by the MeNB, a key S-KeNB1 of the first SeNB and a key S-KeNB2 of the second SeNB;
sending SeNB addition requests to the first SeNB and the second SeNB, wherein the addition requests include the S-KeNB1 or the S-KeNB2;
receiving, by the MeNB, a first request acknowledgment message corresponding to a SeNB addition request sent to the first SeNB;
receiving a second request acknowledgment message corresponding to a SeNB addition request sent to the second SeNB; and
sending, by the MeNB, an RRC reconfiguration request to the UE according to the first request acknowledgment message and the second request acknowledgment message, wherein the RRC reconfiguration request includes key update information of the first SeNB and key update information of the second SeNB, so as to trigger the UE to perform a key update.

2. The method according to claim 1, wherein calculating, by the MeNB, a key S-KeNB1 of the first SeNB and a key S-KeNB2 of the second SeNB comprises:
obtaining, by the MeNB, a secondary cell group (SCG) counter and an MeNB key M-KeNB, and
calculating the key S-KeNB1 of the first SeNB and the key S-KeNB2 of the second SeNB using a counting value of the SCG counter and the M-KeNB, wherein
the S-KeNB1 is used to generate a data stream encryption key Kupenc1 corresponding to the first SeNB, and the S-KeNB2 is used to generate a data stream encryption key Kupenc2 corresponding to the second SeNB.

3. The method according to claim 2, wherein calculating the key S-KeNB1 of the first SeNB and the key S-KeNB2 of the second SeNB using a counting value of the SCG counter and the M-KeNB comprises:
obtaining a first counting value of the SCG counter, and calculating the S-KeNB1 with reference to the M-KeNB and the first counting value; and
obtaining a second counting value of the SCG counter, and calculating the S-KeNB2 with reference to the M-KeNB and the second counting value.

4. The method according to claim 1, wherein sending SeNB addition requests to the first SeNB and the second SeNB comprises:
sending, by the MeNB, a first SeNB addition request to the first SeNB using an X2-C interface, wherein the first SeNB addition request includes a security capability of the UE and the S-KeNB1, so as to trigger the first SeNB to calculate the data stream encryption key Kupenc1 according to the security capability of the UE and the S-KeNB1; and
sending, by the MeNB, a second SeNB addition request to the second SeNB using the X2-C interface, wherein the second SeNB addition request includes the security capability of the UE and the S-KeNB2, so as to trigger the second SeNB to calculate the data stream encryption key Kupenc2 according to the security capability of the UE and the S-KeNB2.

5. The method according to claim 1, wherein sending, by the MeNB, an RRC reconfiguration request to the UE according to the first request acknowledgment message and the second request acknowledgment message comprises:
obtaining, by the MeNB, the key update information of the first SeNB from the first request acknowledgment message, and obtaining the key update information of the second SeNB from the second request acknowledgment message; and
adding, by the MeNB, the key update information of the first SeNB and the key update information of the second SeNB to the RRC reconfiguration request, and sending the RRC reconfiguration request to the UE, wherein
the RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and decryption procedure.

6. The method according to claim 5, wherein the key update information of the first SeNB comprises: a first air interface resource allocated by the first SeNB, first encryption algorithm version information selected by the first SeNB, and the first counting value of the SCG counter and the M-KeNB that are used to calculate the S-KeNB1; and
the key update information of the second SeNB comprises: a second air interface resource allocated by the second SeNB, second encryption algorithm version information selected by the second SeNB, and the second counting value of the SCG counter and the M-KeNB that are used to calculate the S-KeNB2.

7. Abase station, comprising:
a memory, a connector, a processor, a sender, and a receiver, wherein the memory is coupled to the sender and the receiver, and the processor is coupled to the memory, the connector, the sender, and the receiver, wherein the memory stores a set of program code, and wherein the sender, the receiver, and the processor are configured to invoke the program code to perform the following operations:
establishing, by the connector, a Radio Resource Control RRC connection to user equipment UE;
determining, by the processor, a first SeNB and a second SeNB that are connected to the UE;
calculating, by the processor, a key S-KeNB1 of the first SeNB and a key S-KeNB2 of the second SeNB;
sending, by the sender, SeNB addition requests to the first SeNB and the second SeNB, wherein the addition requests include the S-KeNB1 or the S-KeNB2;
receiving, by the receiver, a first request acknowledgment message corresponding to the SeNB addition request that is sent to the first SeNB, and receiving, by the receiver, a second request acknowledgment message corresponding to the SeNB addition request that is sent to the second SeNB; and
sending, by the sender, an RRC reconfiguration request to the UE according to the first request acknowledgment message and the second request acknowledgment message, wherein the RRC reconfiguration request includes key update information of the first SeNB and key update information of the second SeNB, so as to trigger the UE to perform a key update.

8. The base station according to claim 7, wherein the processor is configured to:
obtain a secondary cell group (SCG) counter and an MeNB key M-KeNB, and use a counting value of the SCG counter and the M-KeNB as input parameters, to calculate the key S-KeNB1 of the first SeNB and the key S-KeNB2 of the second SeNB, wherein
the S-KeNB1 is used to generate a data stream encryption key Kupenc1 corresponding to the first SeNB, and the S-KeNB2 is used to generate a data stream encryption key Kupenc2 corresponding to the second SeNB.

9. The base station according to claim 8, wherein the processor is configured to:
obtain a first counting value of the SCG counter, and calculate the S-KeNB1 with reference to the M-KeNB and the first counting value; and
obtain a second counting value of the SCG counter, and calculate the S-KeNB2 with reference to the M-KeNB and the second counting value.

10. The base station according to claim 7, wherein the sender is configured to:
send a first SeNB addition request to the first SeNB using an X2-C interface, wherein the first SeNB addition request includes a security capability of the UE and the S-KeNB1, so as to trigger the first SeNB to calculate the data stream encryption key Kupenc1 according to the security capability of the UE and the S-KeNB1; and
send a second SeNB addition request to the second SeNB using the X2-C interface, wherein the second SeNB addition request includes the security capability of the UE and the S-KeNB2, so as to trigger the second SeNB to calculate the data stream encryption key Kupenc2 according to the security capability of the UE and the S-KeNB2.

11. The base station according to claim 7, wherein the sender is configured to:
obtain the key update information of the first SeNB from the first request acknowledgment message, and obtain the key update information of the second SeNB from the second request acknowledgment message; and
add the key update information of the first SeNB and the key update information of the second SeNB to the RRC reconfiguration request, and send the RRC reconfiguration request to the UE, wherein
the RRC reconfiguration request is used to trigger the UE to calculate the S-KeNB1 and the data stream encryption key Kupenc1 corresponding to the first SeNB, and the S-KeNB2 and the data stream encryption key Kupenc2 corresponding to the second SeNB, so as to activate an encryption and an decryption procedure.

12. The base station according to claim 11, wherein the key update information of the first SeNB comprises: a first air interface resource allocated by the first SeNB, first encryption algorithm version information selected by the first SeNB, and the first counting value of the SCG counter and the M-KeNB that are used to calculate the S-KeNB1; and
the key update information of the second SeNB comprises: a second air interface resource allocated by the second SeNB, second encryption algorithm version information selected by the second SeNB, and the second counting value of the SCG counter and the M-KeNB that are used to calculate the S-KeNB2.

13. User equipment, comprising: a memory, a connector, a processor, and a receiver, wherein the memory is connected to the receiver, and the processor is separately connected to the memory, the connector, and the receiver, wherein
the memory stores a set of program code, and wherein
the receiver and the processor are configured to invoke the program code stored in the memory, to perform the following operations:
establishing, by the connector, a Radio Resource Control RRC connection to a master eNB MeNB, and establish a connection to a first SeNB and a second SeNB;
receiving, by the receiver, an RRC reconfiguration request sent by the MeNB, wherein the RRC reconfiguration request includes key update information of the first SeNB and key update information of the second SeNB; and
performing, by the processor, a key update for the first SeNB and a key update for the second SeNB according to the key update information of the first SeNB and the key update information of the second SeNB.

14. The user equipment according to claim 13, wherein the key update information of the first SeNB comprises: a first air interface resource allocated by the first SeNB, first encryption algorithm version information selected by the first SeNB, and a first counting value of an SCG counter and an M-KeNB that are used to calculate an S-KeNB1; and
the key update information of the second SeNB comprises: a second air interface resource allocated by the second SeNB, second encryption algorithm version information selected by the second SeNB, and a second counting value of the SCG counter and the M-KeNB that are used to calculate the S-KeNB2.

15. The user equipment according to claim 14, wherein the processor is configured to:
calculate the key S-KeNB1 of the first SeNB according to the first counting value of the SCG counter and the M-KeNB that are carried in the key update information of the first SeNB;
calculate the key S-KeNB2 of the second SeNB according to the second counting value of the SCG counter and the M-KeNB that are carried in the key update information of the second SeNB;
calculate a data stream encryption key Kupenc1 corresponding to the first SeNB according to the first encryption algorithm version information and the S-KeNB1 that are carried in the key update information of the first SeNB;
calculate a data stream encryption key Kupenc2 corresponding to the second SeNB according to the second encryption algorithm version information and the S-KeNB2 that are carried in the key update information of the second SeNB; and
perform the key update for the first SeNB according to the S-KeNB1 and the Kupenc1, and perform the key update for the second SeNB according to the S-KeNB2 and the Kupenc2.
